(19) United States
(12) Patent Application Publication
(10) Pub. No.: US 2024/0344706 A1
(43) Pub. Date: Oct. 17, 2024

(54) HEATING COOKER

(71) Applicant: Panasonic Intellectual Property Management Co., Ltd., Osaka (JP)

(72) Inventors: RYOSUKE OTANI, Shiga (JP); DAISUKE YASUKOCHI, Shiga (JP); TAKAHIRO HAYASHI, Shiga (JP)

(21) Appl. No.: 18/579,648

(22) PCT Filed: Sep. 20, 2022
(86) PCT No.: PCT/JP2022/034881

§ 371 Date: Jan. 16, 2024

(30) Foreign Application Priority Data
Oct. 4, 2021 (JP) 2021-163187

(51) Int. Cl. F24C 7/02; H05B 6/64

(52) U.S. Cl. CPC F24C 7/02; H05B 6/642

(57) ABSTRACT

A cooker according to the present disclosure includes a main body, a heating chamber, a microwave heating mechanism, a machine chamber, and a ventilation panel. The heating chamber is provided inside the main body, and accommodates a heating target. The microwave heating mechanism radiates microwaves to the heating chamber. The machine chamber is provided inside the main body and below the heating chamber. The ventilation panel is detachably disposed to the front surface of the machine chamber. The ventilation panel is tilted with respect to the front surface of machine chamber when the ventilation panel is being attached to and removed from the front surface.

### TECHNICAL FIELD

The present disclosure relates to a cooker.

### BACKGROUND ART

In a conventional cooker, a ventilation panel (front grille panel) is detachably installed to a front surface of a machine chamber below a heating chamber (see PTL 1).

### CITATION LIST

### Patent Literature

PTL 1: Japanese Patent No. 6667082

### SUMMARY OF THE INVENTION

In conventional cookers, there is still room for improvement in providing a cooker including a ventilation panel convenient for a user.

An object of the present disclosure is to provide a cooker including a ventilation panel convenient for a user.

A cooker according to one aspect of the present disclosure includes a main body, a heating chamber, a microwave heating mechanism, a machine chamber, and a ventilation panel.

The heating chamber is provided inside the main body, and accommodates a heating target. The microwave heating mechanism radiates microwaves to the heating chamber. The machine chamber is disposed inside the main body and below the heating chamber. The ventilation panel is detachably disposed to a front surface of the machine chamber. The ventilation panel is tilted with respect to the front surface of machine chamber when the ventilation panel is being attached to and removed from the front surface.

The present disclosure can provide a cooker including a ventilation panel convenient for a user.

### BRIEF DESCRIPTION OF DRAWINGS

FIG. 1 is a front perspective view of a cooker according to an exemplary embodiment of the present disclosure.

FIG. 2 is a front perspective view of the cooker with a door opened according to the exemplary embodiment.

FIG. 3 is a front elevation view of the cooker with the door opened according to the exemplary embodiment.

FIG. 4 is a longitudinal sectional view of a front center portion of the cooker with the door closed according to the exemplary embodiment.

FIG. 5 is a partial sectional view showing flow of circulating air inside the cooker with the door closed according to the exemplary embodiment.

FIG. 6 is a partial sectional view of the cooker taken along line A-A of FIG. 3 according to the exemplary embodiment.

FIG. 7 is a front perspective view of the cooker in a state in which a ventilation panel is tilted according to the exemplary embodiment.

FIG. 8 is an exploded perspective view of the cooker in a state in which the ventilation panel and a filter are separated according to the exemplary embodiment.

FIG. 9 is a partial exploded perspective view of the cooker in a state in which the ventilation panel is removed according to the exemplary embodiment.

FIG. 10 is a partial front elevation view of the cooker in a state in which the ventilation panel is removed according to the exemplary embodiment.

FIG. 11A is a front elevation view of the ventilation panel of the cooker according to the exemplary embodiment.

FIG. 11B is a rear view of the ventilation panel of the cooker according to the exemplary embodiment.

FIG. 11C is a top view of the ventilation panel of the cooker according to the exemplary embodiment.

### DESCRIPTION OF EMBODIMENTS

### Findings Underlying the Present Disclosure

The inventors of the present application have intensively studied for providing a cooker including a ventilation panel convenient for a user, and, as a result, have obtained the following findings.

In a conventional cooker, a ventilation panel (front grill panel) is installed detachably from a front surface of a machine chamber below a heating chamber.

However, the ventilation panel need not be completely detached from the front surface of the machine chamber below the heating chamber. For example, without completely removing the ventilation panel, the ventilation panel is opened with the ventilation panel installed to the front surface of the machine chamber, and only a filter may be detached. In this case, a user can remove only a filter, then clean the filter, and return the filter to the ventilation panel again.

Thus, the inventors of the present application have found that a cooker including a ventilation panel that is more convenient for a user than conventional ventilation panels can be provided. Based on the findings, the inventors of the present application have reached the invention mentioned below.

A cooker according to a first aspect of the present disclosure includes a main body, a heating chamber, a microwave heating mechanism, a machine chamber, and a ventilation panel.

The heating chamber is provided inside the main body, and accommodates a heating target. The microwave heating mechanism radiates microwaves to the heating chamber. The machine chamber is disposed inside the main body and below the heating chamber. The ventilation panel is detachably disposed to a front surface of the machine chamber. The ventilation panel is tilted with respect to the front surface of machine chamber when the ventilation panel is being attached to and removed from the front surface.

According to this aspect, a cooker including a ventilation panel convenient for a user can be provided.

The cooker according to a second aspect of the present disclosure further includes a ventilation panel housing part disposed in a front side of the machine chamber, in addition to the first aspect. The ventilation panel is attached to the ventilation panel housing part from obliquely above the front surface of the machine chamber, and the ventilation panel is housed in the ventilation panel housing part when rotated toward a rear side.

According to this aspect, for example, a user can easily attach the ventilation panel to the ventilation panel housing part after the user cleans the ventilation panel.

In a cooker according to a third aspect of the present disclosure, in addition to the second aspect, when the ventilation panel is rotated and tilted toward the front side from the front surface of the machine chamber, the ventilation panel can be removed obliquely upward from the ventilation panel housing part.

According to this aspect, for example, a user can easily remove the ventilation panel from the ventilation panel housing part for cleaning the ventilation panel.

In a cooker according to a fourth aspect of the present disclosure, a ventilation panel includes a filter that is detachable and made of metal, in addition to any one of the first to third aspects. The ventilation panel housing part includes a magnet. When the ventilation panel is housed in the ventilation panel housing part, the ventilation panel is fixed by magnetic force of the magnet.

According to this aspect, for example, a user can easily attach the filter and the ventilation panel to the ventilation panel housing part after the user cleans the filter.

In a cooker according to a fifth aspect of the present disclosure, the ventilation panel includes a filter that is detachable and made of metal, in addition to any one of the first to third aspects. In a state in which the ventilation panel is rotated and tilted toward the front side from the front surface of the machine chamber, the filter is removable from the ventilation panel and attached to the ventilation panel.

According to this aspect, for example, a user can easily remove only the filter from the ventilation panel for cleaning the filter in a state in which the ventilation panel is attached to the ventilation panel housing part.

In a cooker according to a sixth aspect of the present disclosure, in addition to any one of the first to fifth aspects, one of the ventilation panel and the ventilation panel housing part includes a bearing, and the other of the ventilation panel and the ventilation panel housing part includes a shaft. By fitting the shaft into the bearing, the ventilation panel can be rotated in the front-rear direction around the center of the bearing.

According to this aspect, the ventilation panel can easily be attached to the ventilation panel housing part, and the ventilation panel can easily be removed from the ventilation panel housing part.

### EXEMPLARY EMBODIMENT

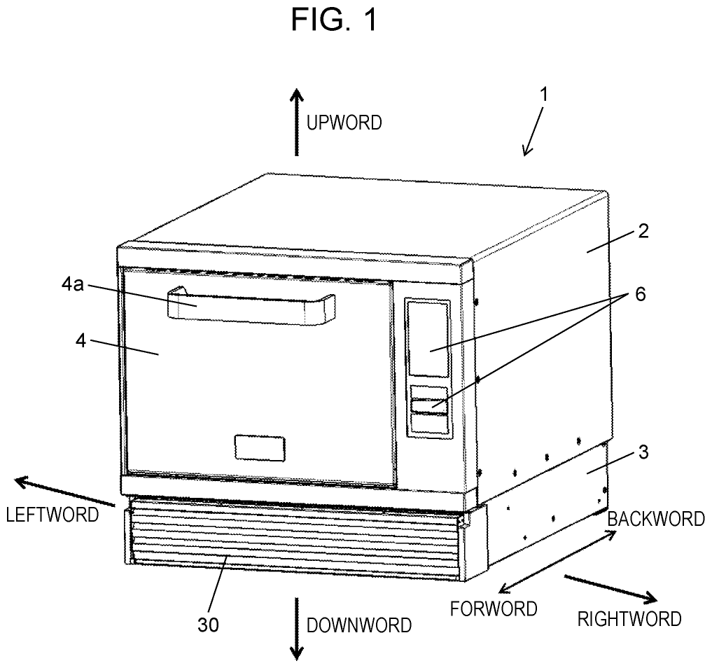

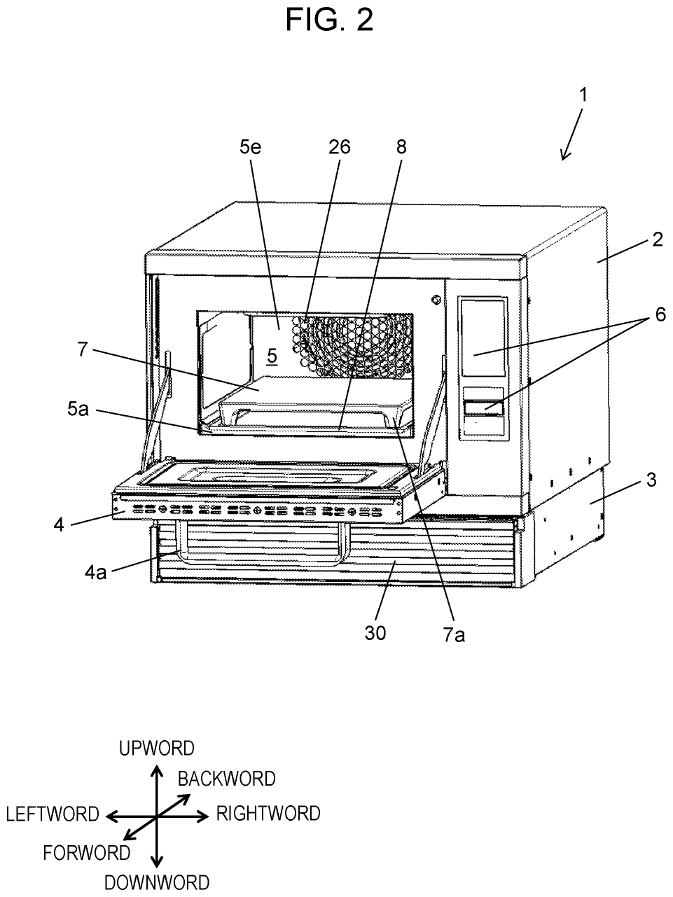

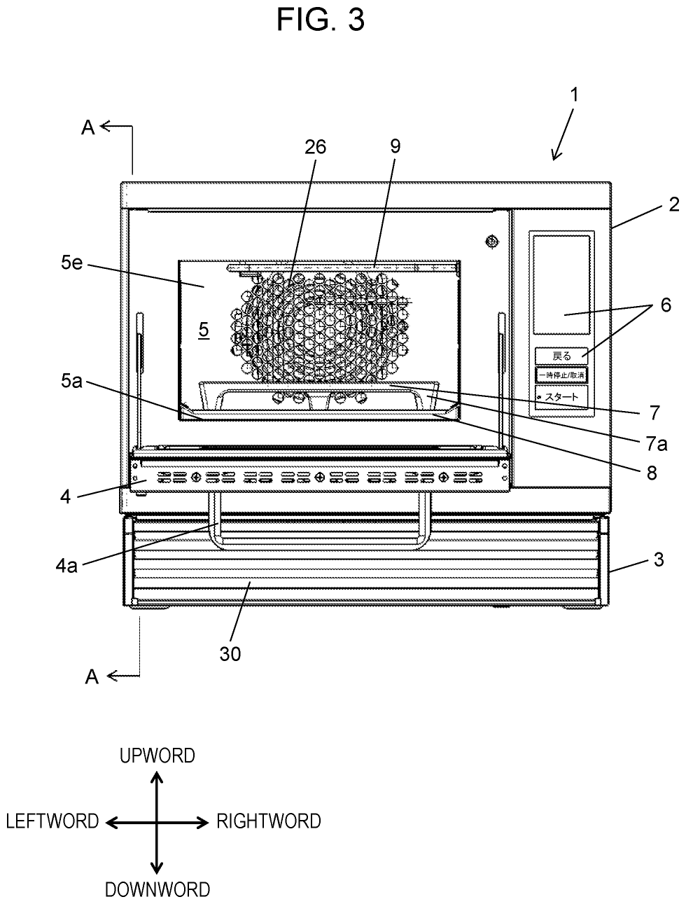

Hereinafter, cooker 1 according to an exemplary embodiment of the present disclosure is described with reference to drawings. FIG. 1 is a front perspective view of cooker 1 with door 4 closed. FIG. 2 is a front perspective view of cooker 1 with door 4 opened. FIG. 3 is a front elevation view of cooker 1 with door 4 opened.

In this exemplary embodiment, as shown in each drawing, the upper side in the vertical direction is defined as an upper side, and a side opposite to the upper side is defined as a lower side. The right side and the left side seen from a user are defined as a right side and a left side, respectively. When a user uses a cooker, the user side of cooker 1 is defined as a front side of cooker 1 and the opposite side to the front side is defined as a rear side of cooker 1.

In this exemplary embodiment, cooker 1 is a high-output cooker for commercial uses, that is, used for convenience stores, fast food stores, and the like. Of course, the present disclosure is also applicable for home-use cookers. Cooker 1 performs any one of microwave heating, the radiation heating, and hot-air circulation heating independently, or at least two of the microwave heating, radiation heating, and the hot-air circulation heating in turn or simultaneously, depending on the cooking content.

As shown in FIGS. 1 to 3, cooker 1 includes main body 2, heating chamber 5, machine chamber 3, and door 4. Heating chamber 5 is provided inside main body 2. Machine chamber 3 is disposed inside main body 2 and below heating chamber 5. Door 4 is disposed on the front surface of main body 2 and covers an opening at the front side of heating chamber 5.

Door 4 includes handle 4a. When a user pulls handle 4a to the front side, door 4 is opened while rotating around hinges provided on the lower part of door 4. The front surface of main body 2 is provided with operating display unit 6 on which a user displays set operations and set contents with respect to cooker 1. On the front surface of machine chamber 3, detachable ventilation panel 30 is disposed.

In a state in which door 4 is closed (see FIG. 1), a heating target inside heating chamber 5 is heated with microwaves. In a state in which door 4 is opened (see FIG. 2), the heating target is accommodated in heating chamber 5, and taken out from heating chamber 5.

Heating chamber 5 of main body 2 includes a substantially rectangular parallelopiped space opening to the front side. Heating chamber 5 is sealed by covering the opening at the front side with door 4, and accommodates the heating target to be heat-cooked. In this state, the heating target is heat-cooked by at least one heating mechanism of a hot-air circulation heating mechanism, a radiation heating mechanism, and a microwave heating mechanism.

The hot-air circulation heating mechanism is disposed in the rear side of heating chamber 5 and in the vicinity of the top surface of heating chamber 5. The radiation heating mechanism is disposed in the vicinity of the top surface of heating chamber 5. The microwave heating mechanism is disposed below bottom wall 5a of heating chamber 5. Bottom wall 5a of heating chamber 5 is formed of materials such as glass and ceramics, through which microwaves easily pass.

Heating chamber 5 can accommodate mount table 7 on which a heating target is to be mounted, and bottom plate 8 disposed below mount table 7 and receiving, for example, fat dripped down from the heating target.

Mount table 7 can be taken out of heating chamber 5. Mount table 7 is formed of, for example, a ceramic table. Mount table 7 integrally formed of a plate member on which a heating target can be mounted, and four leg parts 7a supporting the plate member. Leg parts 7a are mounted on bottom plate 8. Bottom plate 8 is fixed to the upper surface of bottom wall 5a of heating chamber 5.

Bottom plate 8 and mount table 7 are made of ceramics, specifically, made of cordierite. Cordierite is ceramics including magnesium oxide, aluminum oxide, and silicon oxide, has a low thermal expansion coefficient, and is highly resistant to thermal shock. Therefore, even when microwaves are concentrated on the surface of mount table 7, and even when the heating target is heated at high temperatures such as 300° C. or higher, there is no problem in safety of mount table 7.

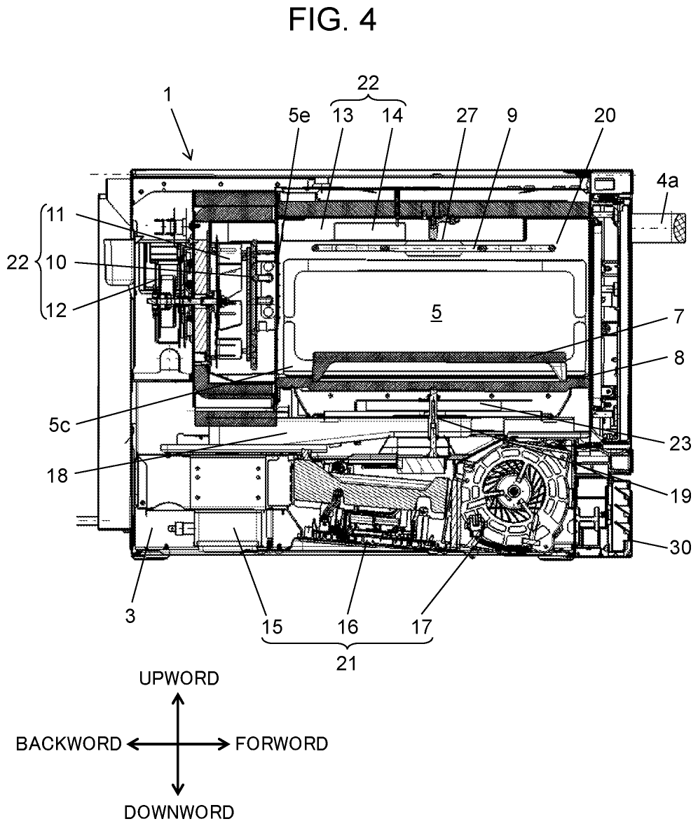

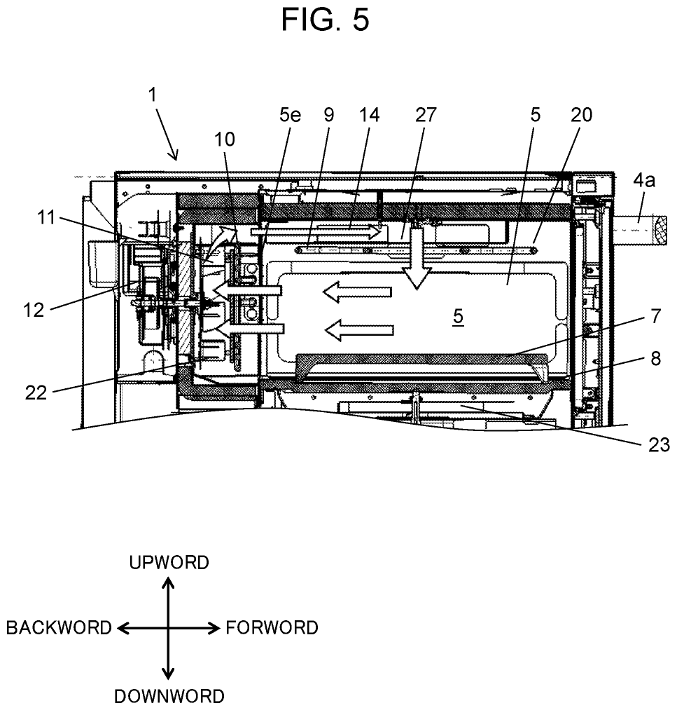

FIG. 4 is a longitudinal sectional view of a front center portion of cooker 1 with door 4 closed. FIG. 5 is a partial sectional view showing a flow of circulating air inside cooker 1 with door 4 closed. In FIGS. 4 and 5, the right side is the front side of cooker 1.

As shown in FIGS. 4 and 5, grill heater 9 constituting radiation heating unit 20 is disposed in the vicinity of the top surface of heating chamber 5. Grill heater 9 is configured with a single sheathed heater, disposed in the vicinity of the top surface and having a bent shape. Grill heater 9 is used in a grill mode (radiation heating) in which a heating target is cooked with radiation heat.

As shown in FIG. 4, microwave heating unit 21 is disposed in machine chamber 3. Microwave heating unit 21 includes magnetron 15, inverter 16, and cooling fan 17. Microwave heating unit 21 is controlled by a control unit (not shown).

The magnetron generates microwaves. Inverter 16 drives magnetron 15. Cooling fan 17 sucks air from ventilation panel 30 provided on the front surface of machine chamber 3, and sends the sucked air to the rear side. This air cools inverter 16, magnetron 15, and the like, disposed inside machine chamber 3. Ventilation panel 30 is described later.

Cooling fan 17 is formed of, for example, a multi-blade fan, takes in air along the rotation axis of the multi-blade fan, and blows the air in the peripheral direction of the multi-blade fan (in this case, toward the rear side of machine chamber 3). The air flows toward the rear side in machine chamber 3, passes through an exhaust duct (not shown) disposed on the rear face of main body 2, and is exhausted from main body 2.

The air for cooling may be exhausted from the front surface of main body 2 after passing through machine chamber 3 and the exhaust duct disposed on the rear face of main body 2, and passing through a space inside main body 2 above the top surface of heating chamber 5. This configuration can prevent the temperature of the rear face of main body 2 from increasing.

Microwave heating unit 21 includes wave guide 18 and microwave supplying unit 19. Wave guide 18 guides the microwaves generated in magnetron 15 to a part below the center portion of heating chamber 5. Microwave supplying unit 19 is an opening disposed below the center portion of heating chamber 5 and formed on the upper surface of an end of wave guide 18. Microwave supplying unit 19 radiates microwaves guided by wave guide 18 to the inside of heating chamber 5.

Stirrer 23 is disposed in the upper part of microwave supplying unit 19, for stirring the microwaves radiated from microwave supplying unit 19. Stirrer 23 is driven by a stirrer driving unit (not shown), and includes blades for stirring the microwaves radiated from microwave supplying unit 19. The stirrer driving unit is a motor disposed inside machine chamber 3.

Accordingly, in cooker 1, the stirred microwaves are radiated from the lower part of heating chamber 5 to the inside of heating chamber 5, and thus a heating target mounted on mount table 7 is heated.

As shown in FIGS. 4 and 5, cooker 1 includes hot-air generation mechanism 22 in addition to radiation heating unit 20 and microwave heating unit 21. Hot-air generation mechanism 22 is controlled by a control unit (not shown) including a microcomputer. Hot-air generation mechanism 22 is disposed inside main body 2 in the rear side of heating chamber 5, and includes convection heater 10, circulation fan 11, and fan driving part 12.

Convection heater 10 is a heat source for hot-air circulation heating. Circulation fan 11 is an air flow source. Fan driving part 12 is a motor for driving circulation fan 11. Heating chamber 5 includes rear wall 5e on which a plurality of openings 26 is formed.

When circulation fan 11 is operated, the air in heating chamber 5 is sucked through openings 26, and reaches hot-air generation mechanism 22. In hot-air generation mechanism 22, the air becomes hot air by convection heater 10 and circulation fan 11. The hot air is blown into the inside of heating chamber 5 from outlet port 27 provided on the bottom surface of flow path forming part 13. The blank arrows in FIG. 5 show the flow of air inside cooker 1.

Hot-air generation mechanism 22 includes below-mentioned flow path forming part 13 and wind guide 14. Flow path forming part 13 and wind guide 14 are disposed in the vicinity of the top surface of heating chamber 5, and regulate the flow rate and the blowing direction of the air blown from outlet port 27 to heating chamber 5.

Flow path forming part 13 and wind guide 14 are disposed in the upper part of heating chamber 5 to form the upper space of heating chamber 5, and regulate the flow rate and the blowing direction of the air flowing in the upper space, and blown out into heating chamber 5.

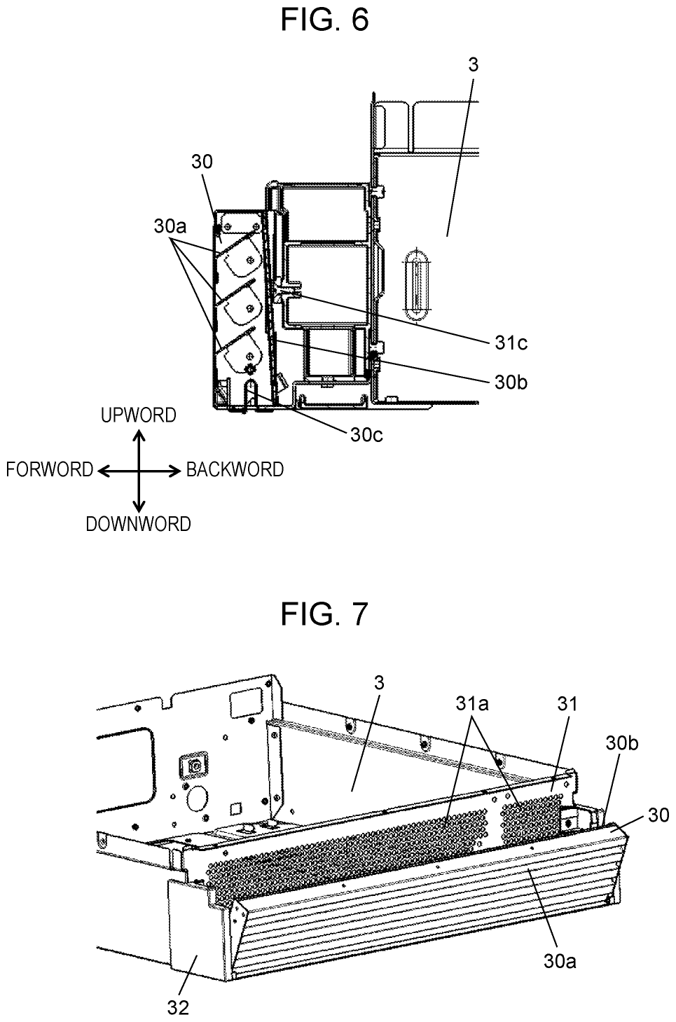

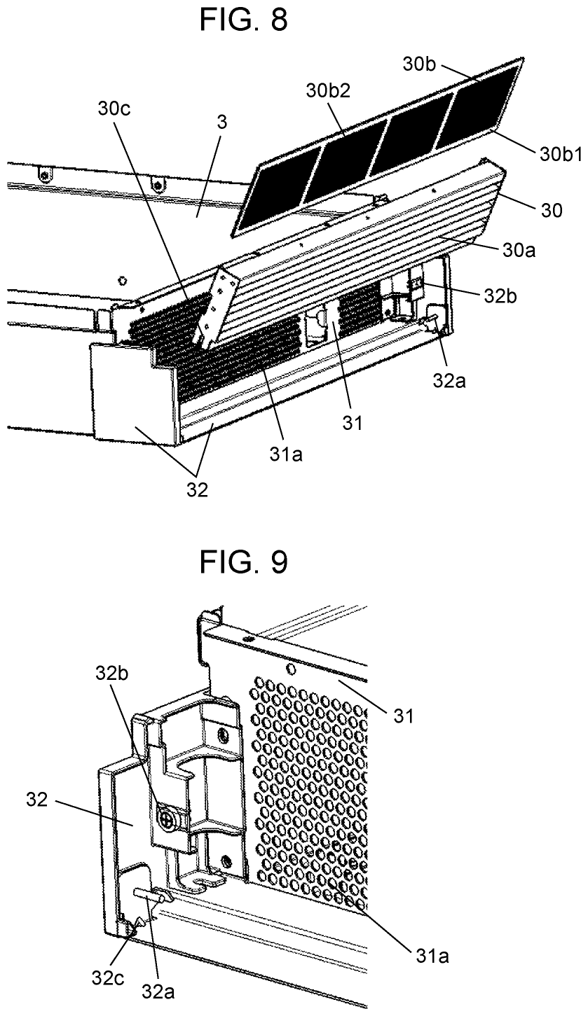

Next, specific configurations of ventilation panel 30 are described. FIG. 6 is a partial sectional view of cooker 1 taken along line A-A of FIG. 3. FIG. 7 is a front perspective view of cooker 1 in a state in which ventilation panel 30 is tilted. FIG. 8 is an exploded perspective view of cooker 1 in a state in which the ventilation panel and a filter are removed.

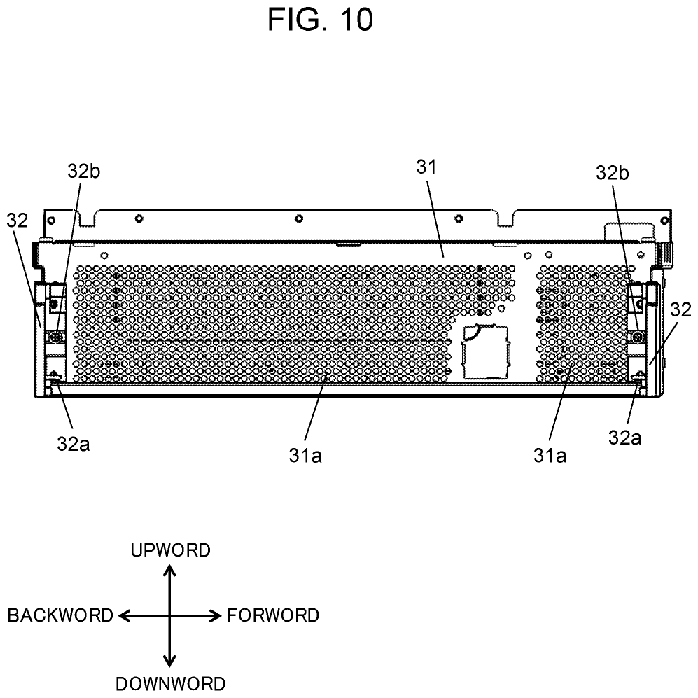

FIG. 9 is a partial exploded perspective view of cooker 1 in a state in which ventilation panel 30 is removed. FIG. 10 is a partial front elevation view of cooker 1 in a state in which ventilation panel 30 is removed.

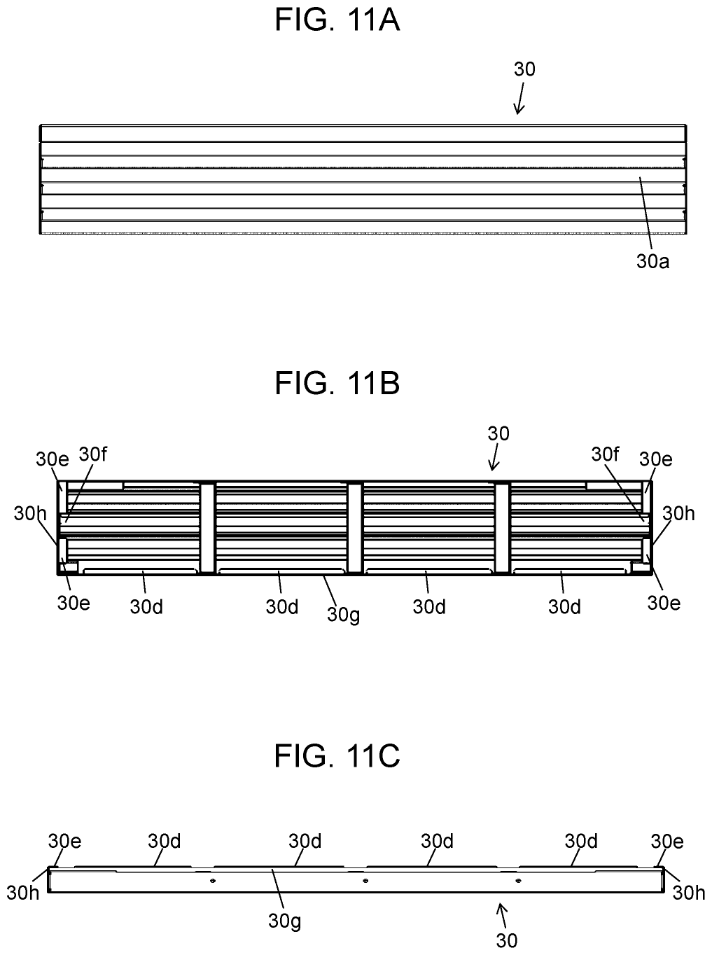

FIGS. 11A to 11C are respectively a front elevation view, a rear view, and a top view of ventilation panel 30 of cooker 1. FIG. 11B shows a state of ventilation panel 30 shown in FIG. 11A seen from the rear side. FIG. 11C shows a state of ventilation panel 30 shown in FIG. 11A seen from the upper side.

As shown in FIG. 6, ventilation panel 30 includes louvers 30a that are a plurality of louvers tilted at a predetermined angle with respect to the front surface of ventilation panel 30. Ventilation panel 30 adjusts the direction of air flow when the air passes through ventilation panel 30.

As shown in FIGS. 6 to 8, front plate 31 forms a front surface of machine chamber 3. Front plate 31 includes a plurality of suction openings 31a formed by, for example, punching. The air sucked through ventilation panel 30 is sent to the inside of machine chamber 3 through suction openings 31a.

In the front side of machine chamber 3, ventilation panel housing part 32, including a bottom part and left and right side parts, is disposed. Ventilation panel 30 is detachably housed in ventilation panel housing part 32.

As shown in FIGS. 7 and 8, the upper end of ventilation panel 30 is pulled toward the front side to tilt ventilation panel 30 with respect to the front surface of machine chamber 3. In this state, ventilation panel 30 can be removed from ventilation panel housing part 32, or ventilation panel 30 can be attached to ventilation panel housing part 32.

With this configuration, cooker 1 including ventilation panel 30 convenient for a user can be provided.

As shown in FIGS. 6 and 8, ventilation panel 30 includes bearings 30c which are cutouts provided at the lower ends of the left and right sides of ventilation panel 30. As shown in FIGS. 9 and 10, ventilation panel housing part 32 includes shafts 32a provided on the left and right side parts thereof, and each of shafts 32 is fitted into corresponding bearing 30c of ventilation panel 30.

By fitting shafts 32a into bearings 30c, respectively, ventilation panel 30 is detachably housed in ventilation panel housing part 32, and furthermore ventilation panel 30 becomes rotatable in the front-rear direction around bearings 30c.

In this exemplary embodiment, ventilation panel 30 includes bearings 30c provided in the lower ends of the left and right side faces thereof, and ventilation panel housing part 32 includes shafts 32a provided in the left and right side parts thereof. However, ventilation panel 30 may include shafts provided in the lower ends of the left and right side faces thereof, and ventilation panel housing part 32 may include bearings provided in the left and right side parts thereof.

As shown in FIG. 9, tilt holding parts 32c, tilted toward the front side and the upper side from the bottom part, are provided on both ends of the bottom part of ventilation panel housing part 32. With tilt holding part 32c, when ventilation panel 30 is attached to ventilation panel housing part 32, ventilation panel 30 is held at a predetermined angle with respect to the front surface of machine chamber 3.

That is to say, as shown in FIG. 7, ventilation panel 30 in a tilted state is installed to ventilation panel housing part 32, and ventilation panel 30 is rotated toward a rear direction around bearings 30c. Thus, ventilation panel 30 can be housed in ventilation panel housing part 32 in an upright state.

On the contrary, ventilation panel 30 is rotated toward a front direction around bearings 30c from the state in which ventilation panel 30 is housed in an upright state in ventilation panel housing part 32. Thus, ventilation panel 30 in a tilted state can be removed from ventilation panel housing part 32.

With this configuration, ventilation panel 30 is attached to ventilation panel housing part 32 from obliquely above the front surface of machine chamber 3. When ventilation panel 30 is rotated toward a rear side, ventilation panel 30 is housed in ventilation panel housing part 32. When ventilation panel 30 is rotated and tilted toward the front side from the front surface of machine chamber 3, ventilation panel 30 is removable obliquely upward from ventilation panel housing part 32 disposed on the front surface of machine chamber 3.

As shown in FIGS. 6 to 8, filter 30b is detachably installed to the back face of ventilation panel 30. Ventilation panel 30 includes filter 30b that is detachable and made of metal. In a state in which ventilation panel 30 is rotated and tilted toward the front side from the front surface of machine chamber 3, filter 30b is removable from ventilation panel 30 and attachable to ventilation panel 30.

As shown in FIG. 8, filter 30b includes frame part 30b1 made of a magnetic metal, and mesh part 30b2 for collecting dust in the air.

As shown in FIG. 6 and FIGS. 8 to 10, two magnets 32b are respectively disposed on the left and right side parts of ventilation panel housing part 32. Specifically, a first magnet of the two magnets 32b is disposed on the left side part of ventilation panel housing part 32 facing the left end of frame part 30b1 of filter 30b. A second magnet of the two magnets 32b is disposed on the right side part of ventilation panel housing part 32 facing the right end of frame part 30b1 of filter 30b.

When ventilation panel 30 to which filter 30b is attached is housed in ventilation panel housing part 32, the left and right ends of metal frame part 30b1 of filter 30b are attracted by magnetic force of corresponding magnets 32b. Thus, ventilation panel 30 provided with filter 30b can be fixed by magnetic force of magnets 32b.

When ventilation panel 30 is housed in ventilation panel housing part 32 without attaching filter 30b to ventilation panel 30, when ventilation panel 30 is formed of a member such as metal or resin that is not affected by magnetic force, magnetic force of magnet 32b does not work. Consequently, ventilation panel 30 cannot be housed and held in ventilation panel housing part 32 in an upright state.

In this case, a user can notice that filter 30b is not attached to ventilation panel 30. The user can securely attach filter 30b to ventilation panel 30, and then allow ventilation panel 30 to be housed in ventilation panel housing part 32.

As shown in FIGS. 11B and 11C, filter lower portion receiving part 30g and filter lower portion pressing parts 30d are provided at the lower end of ventilation panel 30. Filter side portion receiving part 30h and filter side portion holding part 30e are provided at each of the left and right ends of ventilation panel 30.

Each filter lower portion pressing part 30d is a claw formed by partially folding the edge portion of filter lower portion receiving part 30g and protruding toward the upper side from the edge portion of lower portion receiving part 30g. Each side portion holding part 30e is a claw formed by partially folding the edge portion of each of filter side portion receiving parts 30h and protruding toward the center in the left and right direction of ventilation panel 30 from filter side portion receiving part 30h. With these configurations, filter 30b can be attached to the rear side of ventilation panel 30.

As shown in FIG. 11B, magnet facing position 30f is provided in the center portion of the filter side portion holding part 30e in the vertical direction. Magnet facing position 30f is a cutout provided in the center portion in the vertical direction of filter side portion holding part 30e.

Frame part 30b1 of filter 30b faces magnets 32b at left and right ends thereof. Therefore, when ventilation panel 30 to which filter 30b is attached is housed in ventilation panel housing part 32, the left and right ends of metal frame part 30b1 of filter 30b are attracted by magnetic force of magnet 32b. Thus, ventilation panel 30 provided with filter 30b can be fixed by magnetic force of magnet 32b.

### INDUSTRIAL APPLICABILITY

The present disclosure can provide a cooker including a ventilation panel convenient for a user. The technology according to the present disclosure is applicable to microwave ovens, oven toasters, and the like, for commercial use and home use.

### REFERENCE MARKS IN THE DRAWINGS

1 cooker
2 main body
3 machine chamber
4 door
4a handle
5 heating chamber
5a bottom wall
5e rear wall
6 operating display unit
7 mount table
7a leg part
8 bottom plate
9 grill heater
10 convection heater
11 circulation fan
12 fan driving part
13 flow path forming part
14 wind guide
15 magnetron
16 inverter
17 cooling fan
18 wave guide
19 microwave supplying unit
20 radiation heating unit
21 microwave heating unit
22 hot-air generation mechanism
23 stirrer
26 opening
27 outlet port
30 ventilation panel
30a louver
30b filter
30b1 frame part
30b2 mesh part
30c bearing
30d filter lower portion pressing part
30e filter side portion holding part
30f magnet facing position
30g filter lower portion receiving part
30h filter side portion receiving part
31 front plate
31a suction opening
32 ventilation panel housing part
32a shaft
32b magnet
32c tilt holding part

1. A cooker comprising:
a main body;
a heating chamber provided inside the main body to accommodate a heating target;
a microwave heating mechanism for radiating microwaves to the heating chamber;
a machine chamber disposed inside the main body and below the heating chamber; and
a ventilation panel detachably disposed to a front surface of the machine chamber,
the ventilation panel is tilted with respect to the front surface of machine chamber when the ventilation panel is being attached to and removed from the front surface.

2. The cooker according to claim 1, further comprising a ventilation panel housing part disposed in a front side of the machine chamber,
wherein the ventilation panel is attached to the ventilation panel housing part from obliquely above the front surface of the machine chamber, and when the ventilation panel is rotated toward a rear side, the ventilation panel is housed in the ventilation panel housing part.

3. The cooker according to claim 2, wherein when the ventilation panel is rotated and tilted toward the front side from the front surface of the machine chamber, the ventilation panel is removable obliquely upward from the ventilation panel housing part.

4. The cooker according to claim 1, wherein
the ventilation panel includes a filter that is detachable and made of metal,
the ventilation panel housing part includes a magnet, and
when the ventilation panel is housed in the ventilation panel housing part, the ventilation panel is fixed by magnetic force of the magnet.

5. The cooker according to claim 1, wherein
the ventilation panel includes a filter that is detachable and made of metal and
in a state in which the ventilation panel is rotated and tilted toward the front side from the front surface of the machine chamber, the filter is removable from the ventilation panel, and attachable to the ventilation panel.

6. The cooker according to claim 1, wherein one of the ventilation panel and the ventilation panel housing part includes a bearing, and an other of the ventilation panel and the ventilation panel housing part includes a shaft, and
wherein by fitting the shaft into the bearing, the ventilation panel is rotatable in a front-rear direction around the bearing.
